(19) United States
(12) Patent Application Publication
(10) Pub. No.: US 2006/0152345 A1
(43) Pub. Date: Jul. 13, 2006

(54) Antislip mat

(76) Inventor: Matthew Aitkenhead, Wilstead (GB)

Correspondence Address: Bradley N Ruben, Suite 5A, 463 First Street, Hobokern, NJ, 07030-1859, US

(21) Appl. No.: 10/527,504

(22) PCT Filed: Sep. 10, 2003
(86) PCT No.: PCT/GB03/03946

§ 371 Date: Mar. 10, 2005

(30) Foreign Application Priority Data
Sep. 10, 2002 (GB) 0220922.9

(51) Int. Cl. B32B 7/00; G11B 5/64; B41M 5/00; B32B 7/12; G08B 3/00

(52) U.S. Cl. 340/384.1; 428/343; 428/119; 428/195.1; 428/141

(57) ABSTRACT

A mat device or retaining device formed from a plastics material, wherein part or all of the surface of said mat possesses adhesive properties.

### FIELD OF THE INVENTION

The present invention relates to mats. It is particularly applicable, but in no way limited, to anti-slip mats used to prevent objects sliding on a surface. For the sake of this document, where the word ‘mat’ is used, this in fact infers a universal device for assisting in the gripping of objects.

### BACKGROUND OF THE INVENTION

A variety of mats on the market assist in securing objects/items to a surface by providing traction or friction due to the nature of the mat material and its surface structure. These are used mostly in situations where the object may be in motion and the inertia of the object is interrupted by a change in motion, for example the speed or direction may alter. The most common use of these types of mats is in vehicles, for example automobiles such as cars and trucks and in aeroplanes, boats, trains etc.

These friction-aiding devices are usually made from multiple compound plastics that are often foamed into an appropriate sheet. Often a ‘criss-cross’ pattern is used.

These mats are not adhesive in their nature and may slide on a polished surface and objects placed on the mats frequently slide off too easily when a sharp, sudden change in motion may occur. This lack of true grip of an article can become even more evident when there is a vibration, such as in motor vehicles, trains and aeroplanes. The effectiveness of these mats with regard to solving this problem is subjective considering that they are often marketed as essential safety devices within the car. Whilst improved in car safety is claimed, these devices fail to completely eliminate the slipping of articles on a car dashboard or mid console, in turn do not completely eliminate the distraction of the eye from the road.

The ability to custom cut the previously developed mats has been seen to be a unique selling point of these products, however their primary intended function has seemingly been underachieved every time. The apparent failure of these other devices, in spite of extensive efforts, is proven by the evidenced fact that such a device is not sold or made generally available in automotive supply stores, mobile phone shops, supermarkets and the like, at least when compared to other items such as air fresheners.

Another reason for their failure as a product sold on a mass scale is also likely to be their respective poor aesthetic qualities. Much of this may be related to the nature of the material in surface structure, as it does not allow easily for any additional visuals, be it by print or any other method (object insertion for example). It would be quite desirable to provide a way of incorporating detailed graphics into a non-slip mat, without reducing the amount of surface area that contributes to traction of these mats by the addition of an ink/print surface or detail in certain areas.

Another product on the market aimed at securing a personal item is that of a mobile phone holder. These often require installation and are visually bulky, because they grip a large portion of the body of the phone. Alternative holders that use a magnetic base have challenged this aesthetic problem. These types of holders however require the mobile phone to have constantly placed on the back of it a small strip of metal that is glued to its back to attract the magnet, undesirably impeding on the original design of the phone or interfering with the ariel of the phone.

The objective of the present invention therefore becomes that of providing a primarily low cost device with high holding properties that significantly improves upon some of the features in the prior art devices. It Is a further objective to incorporate other features believed to be novel to a device of this type and aimed at providing a much more versatile and effective anti-slip traction and holding device than has heretofore been available, with a wide range of applications In assisting gripping articles and attracting particles. It can also easily allow for the device to be improved upon aesthetically by the addition of visuals via print or integral insertion, and by minimising the amount of parts needed to serve the same functional objective. The interaction between product and consumer can also be enhanced by the addition of some simple features easily achievable in production, from touch sensitive ‘talking mats’ to the simple two part moulded product to accommodate a visual object of choice, such as a photograph. Other possible developments of these devices may incorporate a design tailored for holding music CD's, the internal integration of a manipulative mesh to create a flexible device, and a skin form of the device.

According to a further objective, a method is provided for improving the holding mechanics between the mat and any article placed on it without the need for using adhesives.

### SUMMARY OF THE INVENTION

According to a first aspect of the present invention there is provided a mat device formed from a plastics material, the surface of said mat possessing adhesive properties. By providing a positive adhesive, the mat itself will adhere to surfaces, preferably clean surfaces, on which it is laid, such as a car dashboard, and items will in turn adhere to the mat.

Preferably the mat device is formed from a polyurethane gel. Such gels have, if properly formulated, inherent adhesive properties that are long lasting even after washing. Water can be used to clean the mat and restore full adhesion.

Preferably a mat device according to this invention is prepared by dispensing liquid polyurethane gel into a shaped mould, said mould can also be part of the point of sale packaging for the mat device. The gel cures inside the mould, either at room temperature or on heating, and no further handling of the product is necessary. Preferably the mat device is formed into ah aesthetically eye-catching shape.

In an alternative embodiment a mat device is formed from a flexible substrate whose surface is coated with a low-tack/medium-tack adhesive.

Preferably a mat device according to the present invention is formed in the shape of a thin sheet, having an upper surface and a lower surface and an edge surface, wherein both upper and lower surfaces have adhesive properties. The process of using the packaging as the mould for the product can in fact be used in producing other sticky products for similar but differing and more focused applications (holding CD's in particular). More three-dimensional objects can be formed using this method (as is the before mentioned development) that may be more marketable due to the visual enhancement over a two dimensional (mat like) device due to the increased possibilities in design.

In a preferred embodiment mat incorporates an adhesive surface on one face of the mat and the opposing face of the mat incorporates one or more holding shapes adapted to engage with an article. In a preferred example the holding shape(s) are adapted to extend through and grip the central spindle hole of a CD.

Preferably the mat device incorporates an image and it is particularly preferred that the image is formed on a separate component.

Preferably the image component Is retained in a complementary shaped recess formed in one surface of the mat. The image may be of a holographic or other “moving image” type, where motion is simulated by altering the angle from which the image is viewed.

Preferably the device further incorporates a substantially non-elastic, deformable material such that the mat can be bent to adopt a particular shape. A preferred example is where the deformable material comprises wire.

In alternative preferred embodiments the plastics material used to form the mat device incorporates one or more classes of material selected from the list comprising:—

a luminescent coloured pigment

a fluorescent coloured pigment

a thermochromic pigment

a fragrance

an air freshener.

In a further embodiment mat device further incorporates components adapted to generate sound. Such sound components include, but are not limited to, an energy source, a speaker, and a solid state electronic device incorporating pre-recorded sound and a switch.

Preferably the device is in the shape of a thin sheet, having an upper surface and a lower surface and an edge surface, wherein both upper and lower surfaces have adhesive properties.

According to a second aspect of the present invention there is provided a method of manufacturing a mat device comprising the steps of:—

(a) forming a mould;

(b) dispensing into said mould a suitable amount of plastics material;

(c) allowing said plastics material to set;

(d) covering the open face of the mould to form point of sale packaging.

Preferably the plastics material is a polyurethane material with inherent low tack/medium tack properties.

In a further preferred embodiment, further components can be placed in the mould, such components include an image, wire or other substantially non-elastic deformable materials, sound producing components or the like.

### BRIEF DESCRIPTION OF THE DRAWINGS

The present invention will now be described by way of example only with reference to the following drawings wherein:—

FIGS. 1 and 3 show side, front and end elevations respectively of a mould for a mat according to the present invention. FIG. 2 shows a plan view.

### DESCRIPTION OF PREFERRED EMBODIMENTS

Embodiments of the present invention are described below by way of example only. These examples represent the best ways of putting the invention into practice that are currently known to the Applicant although they are not the only ways in which this could be achieved.

According to a first aspect the invention comprises a mat formed from a plastics material that has an inherently sticky surface. Such a surface can be referred to as having a tacky or low-tack or medium tack adhesive properties. Such a mat can be formed in a mould that also becomes the packaging.

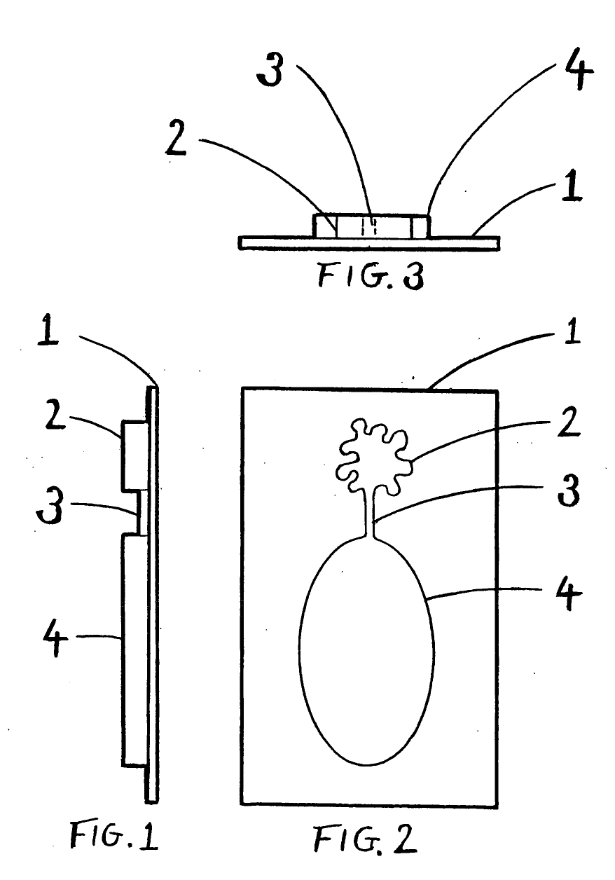

Referring to FIGS. 1, 2 and 3, vacuum forming or injection moulding (dependent on batch size) is used to form the mould (1) for the mat products. Polyethylene plastic is the preferred plastic for the mould (or a PVC sheet with a thin PE skin could be used as a cost effective alternative) as it allows for other possible plastics but especially polyurethane gel to cleanly pull away from its surface. When the preferred plastics material is poured into the mould and set, the end product/s are made. A sheet of thin plastic or card may be then placed onto and over the open face of the mould and heat-sealed if needed to provide the main structure and sealing body of the product's packaging. A number of affixing methods can be applied to add the relevant desired graphics to the product via print or card for example.

A further development in using these materials this way could provide a CD holder. These products could be used for holding CD's when they are out of their case/packaging and one could also use them to display CD's (especially music CD's known for their colourful and highly visual graphic design), especially on walls, to make in essence a kind of visual montage of CD's, a ‘virtual poster and could also be useful when ‘juggling’ a few CD's out of their cases at any one time.

In this embodiment, the form that the packaging, (the mould for the CD product), would take would be a central spigot, (preferably from 2 mm to 20 mm, which acts as the male holder for the central hole within the CD from which a set of thin spokes would spread outwards (acting as anti-scratch guards, separating the CD's surface from the body of the mat). The moulding process would preferably thus be two part. Firstly a non-tacky composition of PU gel (parts ratio of 1:1 should be adequate) would fill the main part of the mould, followed by a much more sticky thin layer of gel (ratio 2:1 for example). This second layer acts as the base for the product that is stuck to the wall or whatever surface is desired, be it the side of a computer, speaker or music system.

This is just one example of a range of products which consist of a mat with an adhesive surface on one face and with holding shapes on the opposing surface where the holding shapes are adapted to engage with, hold or attach to an article or series of articles.

The inability to print effectively (especially in detail) on these types of flexible, tacky plastics materials means that moulding the mat allows for some surface detailing and the ability to cast within the mat an image. This proves a considerable advantage in allowing for an image such as a brand logo and gives the ability to form a more three-dimensional mat if desired for purpose of improved function or form.

The preferred raw material used to make the polyurethane gel mat needs to be heated to allow it to pass through mixing machine pipes and injection heads. Thus when entering into the moulds (2 and 4), the thin sheet of polyethylene (1) (preferable from around 0.3 mm to 3 mm thick) may heat with the product slightly and cool with it.

However any slight expansion or shrinkage movement that may occur of the two materials would be synchronised, and no adhesion would occur between the two materials.

The preferred plastics material will be selected by a materials specialist. However, polyurethane gel is deemed the most suitable material due to its application suitability. It has a high enough tear strength for the applications described and is not publicly perceived as a health threat with regard to human contact as with other plastics such as PVC that can be plasticised. Polyurethane gel is more stable than many other similar plastics when in a ‘soft’ form, allowing for far less potential leakage of additives that may be required such as UV stabilisers, fire retardant etc.

This material is very flexible, allowing it to sit over most curved surfaces and it may also be cut to shape if desired. A further advantage of the invention in using this type of material is there is no need for high-pressure injection moulding, hence potential for low cost tooling cost for this product type. Moreover, another development in using PU gel is that is can be cured at room temperature, an advantage for smaller batch production.

Any such plastic with the same low tack or medium tack quality as PU gel may be used if seen fit to the applications mentioned within the product's social and environmental boundaries. PU gel has the advantage over other similar polymers that it secures additives within its finalised structure such as pigments and UV stabilisers, vastly reducing a potential for these bodies to migrate to other surfaces if the product is cured correctly.

Thus, for the first time it has proved possible to restrain a mobile phone handset using a low tack sticky surface (such as PU gel) to hold the phone in place. This is of considerable benefit for securing objects with a convex surface. The production of these mats could also extend to many smaller versions. They could be used as a means to provide a method of attaching objects to a surface, especially seen as advantageous would be the use of notes in this application so there would no longer be a need for drawing pins, ‘blue-tack’ (RTM) or ‘post-it notes’ (RTM).

In a further embodiment this product could incorporate a flexible manipulative surface with memory, such as wire mesh, via a two-part cast moulding method. This would allow the mat to be sculpted into a preferred form to extend the potential use spectrum and interaction between users. In this embodiment the mould is part-filled with gel and a wire or other deformable framework structure is then placed into the partly filled mould before adding the remainder of the plastics gel. The gel forms around and into the pliable framework and the various components form what can be regarded as an integral structure.

Thus the present invention includes both a low/medium tack mats as described herein, and methods of manufacturing such mats wherein the mould in which the mat is formed preferably serves as part of the point of purchase packaging for the mat itself.

In FIG. 2 joining channel (3) can be used to allow the flow of the same material from one cavity to the other. The drawing shows this between the mat (4) and the ‘splat’ shape mobile phone holding aid (2). This is advantageous in design as it allows two entirely different products to be made using only one injection head facilitator. If a separate colour were wanted between the two products, another injection head would be needed. If this were the case the channel (3) would not be present.

Another advantage of moulding the products and using the packaging as the mould for the products, over a method of cutting mats from a sheet is that it allows for simple tooling, something that is very desirable for more intricate shapes such as moulding the ‘splat’ shaped phone aid shown (2). It is possible, for example, to produce a set of sticky alphabet shapes, as commonly found as fridge magnets, as these have great market potential due to the learning and communicative possibilities that these types of products have proven in the past. Schools may use them to encourage a novel fun interaction between learning to spell and young children. Thus it will be appreciated that the invention extends to the manufacture of teaching aids. In this context, the term ‘mat’ and ‘teaching aid’ are intended to be interchangeable. When devices according to the invention are used as teaching aids it is only necessary for one surface to possess adhesive properties, to keep the aid in place.

It is also advantageous to incorporate common ‘glow in the dark’ luminescent or fluorescent additives to these types of holding aids, to add a degree of fun and extended function to the products. These types of additives can be applied to the PU gel in accordance with manufacturers guidelines. If desired, thermochromic pigments may be added to the gels. These pigments change colour at pre-determined temperatures. Alternatively the change may be from coloured to colourless. Such thermochromic pigments are known per se and are commercially available from Matsui Inc. or The Pilot Ink Company of Japan.

A rounded edge also allows room for the finger to come underneath the edge of the mat, making it preferably easier to pull the mat off its surface and acting in essence as a virtual ‘pull tab’.

In a further embodiment of the invention it is possible to heat fuse or glue the same or similar chosen material of a differing tone or colour (in a thin skin form, or alternatively dropped into a mirroring recess) onto the surface to achieve an image.

The further improved device of the Invention would allow an even more viable and flexible method of achieving a wide range of printed design. A pre-printed image (for example a plastic sheet of acetate) could be positioned in the middle of the Polyurethane gel mould. This could be done in many ways, for example a two-part casting or the image could be inserted during the casting process itself, the latter being the preferred method due to lower manufacturing cost. The addition of images could be potentially extremely beneficial to the marketing of the mat (4), as endorsed ‘in-car’ personal products are especially successful in today's current climate. This insertion process could even allow for objects to be integrally cast, dried flowers for Instance.

Another improvement on the invention that may be used in conjunction with the above method is the insertion of a visually ‘moving’ graphic. This has the ability to easily and effectively increase the consumer's appeal to the product. This can be achieved by either inserting an image that incorporates a hologram, a prismatic image altering surface effect or by using a new printing technology called metal FX (see www.metal-fx.com for more information).

A further embodiment is the use of polyurethane gel within a mat of this type. The most favourable dimensions for a mat to be used in daily applications where articles are to be held in place, where the mat may assist in gripping objects in the hand and where the mat may be used to aid in cleaning surfaces are between 0.1 mm and 40 mm thick, and 0.1 to 4000 mm long and/or wide. The minimum thickness of 0.1 mm is preferable for producing a skin type mat that can be used for holding up posters to the wall or providing a means of tearing away strips/multiple layers of mat to reveal a fresh surface, eliminating the need for washing the mat with water. This may be best achieved by placing a spreader head directly after the dispensing head of the PU gel and produced in a continual process. This skin can be spread onto a wax paper and then another layer of wax paper can be placed directly on top. The wax papers should also aid in the cutting process, should one wish to stamp out desired shapes.

These dimensions are desirable as they allow easy transport of the mat. It is also a suggested possible useful application of the device to be used in assisting in the grip of objects in the hand. This may be in particular of benefit to the elderly in tasks as simple as opening a jam jar to carrying thin heavy plastic shopping bags. The sticky nature of the material also allows for the mat to be rolled up (securing itself) and put into the pocket. A further development of the improved device in using a sticky material such as polyurethane gel allows for the same product to be placed semi-permanently together (back to back). This allows potential product diversity in a two-tone system, a marketing angle that is possible for the product if different colour mats are made as a range.

Another means of increasing marketing potential of these types of products is to enhance consumer interactivity via the insertion of a touch sensitive pre-programmed speaker/battery. A small flat speaker and small (perhaps lithium) battery are preferred (as are commonly found in greeting cards) that could be inserted in a number of ways. A two part moulding process is an obvious and relatively practical method of achieving this. This may be especially beneficial for the endorsed product market, so that characters such as in ‘The Simpsons’ could say comical puns when a mobile phone for instance is placed on the mat. A simple solar panel could also be included within the system to further extend the battery life of the product.

A mat according to the present invention may also be employed to clean loose particles such as lint and dirt from textile surfaces such as the upholstery of a car or clothes, something that prior mats have not been capable of performing. The device of the instant invention may be employed to such an application by the nature of polyurethane itself. The material has a unique very inherently sticky quality that can be entirely rejuvenated when washed with water, eliminating any need for adhesives that may leave a residue on anything it touches. The sticky mat could be pressed against dirty textile surfaces where the particles would adhere to the mat. This potential use for the product could be very high, as car owners who may wish to quickly clean their car interior or clothes without having to resort to using a brush, vacuum cleaner or detergents could also use the mat.

All forms of these sticky devices could also incorporate a method for containing an air freshener, a further improvement to the product concept and a highly marketable innovation to current mats and air fresheners.

An advantage of using the chosen material is that it allows for the mat to be placed on a flat or a contoured surface due to its flexible nature whilst still holding firm all items placed on it. This can be seen as advantageous to people who may use the mat to keep tidy very small objects, especially hobbyists such as fishermen, artists, model makers and even people such as jewellers to the everyday DIY person.

The especially sticky quality of the mat allows for smaller objects such as screws, hooks and needles to be literally held in place as opposed to a mat merely providing a means to prevent them being blown away or moved under relatively very low forces. Previous anti-slip mats, three dimensional in their net like form would allow for small objects to constantly fall in-between their piles. The novel use of this new material allows even for objects as heavy as mobile phones to be held upside down on its surface, something mats of this type have never been capable of. The material also has fine shock absorption qualities, which may be seen to be ideal for those who use the mat to hold down portable motion sensitive electronic equipment such as a CD player. In using this material for this type of mat, it also allows for only a small part of the surface area of an object to be touching it to provide ample grip and stability of the object, allowing smaller mats to be produced to serve the same objective.

In the embodiments described above, the mat has been formed from a flexible plastics material that has inherent adhesive properties on its surface. Such plastic materials are available, for example, from ‘Northstar Polymers’ (USA) under supplier code MPP-V37A. It is possible that both low-tack, medium tack and high-tack polymers can find use in the invention depending on the items that are to be held in place by the mat.

The preferred polymer for each application will be determined by the materials specialist in conjunction with the polymer manufacturer. However, polyurethanes formed from DMI and known polyethers have suitable and satisfactory properties.

In an alternative embodiment the mat may be formed from some other plastics material that is not necessarily sticky. However, a proprietary low-tack or medium tack adhesive may be applied to the surface of the mat, giving it the necessary adhesive or ‘grab’ properties. Such tack adhesives are now widely available and may be found for example at ‘Advanced Adhesive Technology, Inc’ USA and ‘Adamin Industries’-Canada.

The inherent flexibility of the mat itself means it will follow the contours of virtually any surface it is placed on, sticking to that surface on its underside whilst still providing an upper, sticky surface for items to adhere to.

The present invention thus provides a unique low cost way of producing a cohesive product system of an attractive and portable mobile phone holding aid and an anti-slip mat, universal in use with many other applications outside its primary intended use of helping to hold objects down and also when a sudden change of motion may occur. It may also be used to clean lint and other particles from upholstery and other textile surfaces. Additionally it can aid the disabled in daily tasks.

It will be appreciated from the foregoing description that the “mats” described herein are not intended as floor mats. Rather, they are retaining devices intended to adhere themselves to a surface on one face and, in most cases, to adhere some other item or items to the opposing face. Thus, it would be more apt to describe articles according to the present invention as “retaining devices”. The term ‘mat’ and the term ‘retaining device’ are therefore to be considered equivalent and interchangeable throughout this description and in the claims.

In summary there is provided a device for assisting in holding down objects, aiding in the grip of the hand on objects, picking up ‘loose’ particles and a low cost production method of the mat by using the packaging itself as the mould. This includes:—
a) A soft/‘cold’ one or two piece (depending on preferred production method) moulded plastic mat (preferably a polyurethane gel or PU compound), with a prime use as a mobile phone aid, that has within its end nature a permanently sticky surface that is rejuvenated when washed with water and leaves no residue.
b) The inventive method of producing these products may best be achieved by using part of the actual packaging as the mould. This is instead of transferring a moulded part or a cutting from a sheet of material into a separate body of packaging, thus reducing cost and time in production.
c) The novel use of a sticky material (PU gel is the preferred choice) within a mat for intended applications.
d) A method is provided to achieve a basic image and colour differentiation within the product
e) A method of Incorporating detailed graphics and images into this product type via insertion.
f) The novel use of a sticky material to produce an air freshener that can subsequently be universally mounted and repositioned.
g) The innovative method of producing a CD holder for organising or displaying. CD's whilst out of their packaging.
h) The novel use of a sticky material to produce a thin skin of material that can be applied universally to hold down or mount relatively light weight objects.
i) The novel incorporation of a manipulative flexible material (such as a wire mesh) into a sticky mat to produce a mat type product capable of retaining its preordained form to meet various applications.
j) A novel use of incorporating the letters of the alphabet (all nations) into smaller units of sticky mats for the enhanced interaction between product and user, and the novel integration of luminescent and fluorescent additives.
k) The inventive method of incorporating a speaker, battery and solar panel into a sticky mat for further increased interaction between user and product.
l) The new use of integrating a visually ‘moving’ two dimensional image such as a hologram via integral insertion in the casting process for increased potential marketing benefits.

The improved anti-slip mat device of the present invention incorporates a vacuum formed or injection moulded thin piece of plastic that also forms part of the packaging and may be the mould itself for the final end product. The objective of the invention is to provide a product products that permits a secure hold of articles to its surface, while retaining advantageous unobtrusive dimensions and the potential for transferring particles from one surface onto that of its own.

In accordance to the present invention there are considerable production, environmental, efficiency and cost advantages by moulding the mat directly into the packaging itself, thus reducing tooling costs and allowing for the attention to detail of the form of the edges of the mat. This is considerably preferable for the products application and numerous other potential aesthetic advantages. Also, another significant advantage here is that two or more products can be arranged in the packaging mould next to each other if desired, allowing for either one or all recesses in the packaging mould to be present, followed by the injection of the Polyurethane gel to make the mats by the same or different injection heads. Different injection heads would allow alternative colours to be used for the mouldings, dependant on the preferred colours of the products. The mouldings may be different sizes and shapes if desired.

Extruding, casting or moulding a large sheet of the preferred plastic and cutting out desired shapes is an alternative way of producing the mats. The sticky nature of the material may make it difficult to cut the sheet into individual items and to produce an even or neat edge. The sticky product/s then need to be placed into packaging as a separate operation to the extruding and cutting processes as each piece is first individually shrink wrapped, as an option, and then transferred to another body of packaging.

The preferred method of production will depend on the shapes, sizes, volumes and numbers required, although the primary novelty of this invention is the use of the packing as the mould itself.

1. A mat device formed from a plastics material, wherein part or all of the surface of said mat possesses adhesive properties.

2. A mat device according to claim 1 formed from a polyurethane gel, which as an inherently sticky surface.

3. A mat device according to claim 1 wherein the mat incorporates an adhesive surface on one face of the mat and the opposing face of the mat incorporates one or more holding shapes adapted to engage with an article.

4. A mat device according to claim 3 wherein the holding shape(s) are adapted to extend through and grip the central spindle hole of a CD.

5. A mat device as claimed in claim 1 wherein the mat device incorporates an image.

6. A mat device according to claim 5 wherein the image is formed on a separate component.

7. A mat device as claimed in claim 6 wherein the image component is retained in a complementary shaped recess formed in one surface of the mat.

8. A mat device according to claim 5 wherein the image is of a holographic or other “moving image” type, where motion is simulated by altering the angle from which the image is viewed.

9. A mat device according to claim 1 wherein the mat device further incorporates a substantially non-elastic, deformable material such that the mat can be bent to adopt a particular shape.

10. A mat device as claimed in claim 9 wherein the deformable material comprises wire.

11. A method for making a mat device wherein the plastics material incorporates one or more classes of material selected from the group consisting of
a luminescent colored pigment
a fluorescent colored pigment
a thermochromic pigment
a fragrance
an air freshener and
combinations of any of the foregoing.

12. A mat device as claimed in claim 1 which further incorporates components adapted to generate sound.

13. A mat device as claimed in claim 12 wherein said sound components include an energy source, a speaker, and a solid state electronic device incorporating pre-recorded sound and a switch.

14. A mat device as claimed in claim 1 wherein the plastics material is dispensed into a shaped mold, said mold also forming part of the point-of-sale packaging for the mat device.

15. (canceled)

16. A mat device as claimed in claim 1 wherein the device is formed from a flexible substrate having a surface coated with a low tack/medium-tack adhesive.

17. A mat device as claimed in claim 1 wherein the device is in the shape of a thin sheet, having an upper surface and a lower surface and an edge surface, wherein both upper and lower surfaces have adhesive properties.

18. (canceled)

19. A method of manufacturing a mat device comprising the steps of:
(a) forming a mold;
(b) dispensing into said mold a suitable amount of plastics material;
(c) allowing said plastics material to set; and
(d) covering the open face of the mold to form point of sale packaging.

20. A method according to claim 19 wherein the plastics material is a polyurethane material with inherent low tack/medium tack properties.

21. A method according to claim 19, wherein a further component is placed in the mould mold, such component selected from the group consisting of an image, wire or other substantially non-elastic deformable material, sound producing components or a combination thereof.

22. (canceled)
